(19) United States
(12) Patent Application Publication
(10) Pub. No.: US 2025/0391179 A1
(43) Pub. Date: Dec. 25, 2025

(54) SYSTEMS AND METHODS FOR DETECTING TRAFFIC LIGHT VIOLATIONS

(71) Applicant: Verizon Patent and Licensing Inc., Basking Ridge, NJ (US)

(72) Inventors: Leonardo SARTI, Florence (IT); Tommaso BIANCONCINI, Florence (IT); Leonardo TACCARI, Florence (IT)

(73) Assignee: Verizon Patent and Licensing Inc., Basking Ridge, NJ (US)

(21) Appl. No.: 18/749,945

(22) Filed: Jun. 21, 2024

(51) Int. Cl. G06V 20/58; G08G 1/01; G08G 1/017; G08G 1/052

(52) U.S. Cl. CPC G06V 20/584; G08G 1/0133; G08G 1/0175; G08G 1/052

(57) ABSTRACT

In some implementations, a server may obtain a video recording of a scene captured by a camera onboard a vehicle. The server may perform an object detection that indicates a presence of a traffic light in a frame of the video recording. The server may determine a red light probability that the frame contains at least one relevant red traffic light for the vehicle. The server may calculate a violation score based on the object detection and the red light probability with respect to the frame. The server may determine whether the vehicle is associated with a traffic light violation based on the violation score in relation to a threshold.

### BACKGROUND

Traffic laws may govern and regulate vehicles on roadways. Traffic laws may define rules involving observing speed limits, observing traffic lights, following traffic signs, yielding to special vehicles (e.g., school buses and emergency vehicles), etc. Individuals that violate traffic laws may be subjected to fines or other types of punishment.

### BRIEF DESCRIPTION OF THE DRAWINGS

FIG. 1 is a diagram of an example associated with detecting traffic light violations.

FIG. 2 is a diagram of an example associated with object detection.

FIG. 3 is a diagram of an example associated with turn detection.

FIG. 4 is a diagram of an example associated with speed detection.

FIG. 5 is a diagram of an example associated with traffic light state classification.

FIG. 6 is a diagram of an example environment in which systems and/or methods described herein may be implemented.

FIG. 7 is a diagram of example components of one or more devices of FIG. 6.

FIG. 8 is a flowchart of an example process associated with detecting traffic light violations.

### DETAILED DESCRIPTION OF EXAMPLE EMBODIMENTS

The following detailed description of example implementations refers to the accompanying drawings. The same reference numbers in different drawings may identify the same or similar elements.

A camera may be installed on a dashboard of a vehicle and capture video of the road when the vehicle is driving on the road. The vehicle may be a connected vehicle. The camera may be an onboard camera, mounted on the dashboard, that records a scene associated with the vehicle. The camera may start capturing video after the vehicle is turned on and may stop capturing video after the vehicle is turned off. When the camera detects an event (e.g., hard acceleration or harsh cornering), a video recording from the captured video may be created. The video recording may include video of the road and surrounding areas associated with the event. For example, the video recording may include objects near the vehicle, such as stop signs, traffic lights, and/or surrounding vehicles. The camera may send the video recording to a server. The server may review the video recording, and based on the video recording, the server may classify the event using a video detection algorithm. For example, the server may classify the event as being related to an unsafe driving behavior. Alternatively, the classification of the event may be performed by a local computing device associated with the vehicle. A notification may be sent to a driver of the vehicle and/or a supervisor. Depending on the video recording and the classification of the event, the driver may be coached in safter driving habits.

In one example, the event may be a red traffic light violation. The red traffic light violation may occur when the vehicle crosses an intersection after a traffic light controlling the intersection has turned red. In other words, the red traffic light violation may occur when the vehicle enters the intersection (e.g., passes a stop bar) after the traffic light has turned red. A detection of the red traffic light violation may involve determining a state of the traffic light in the scene, determining which traffic light is relevant to the vehicle, and/or determining whether the vehicle is crossing the relevant traffic light when the state of the traffic light is red.

However, detecting red traffic light violations in video recordings obtained from connected vehicles may be difficult, and in some cases, red traffic light violations may be mistakenly detected or not detected altogether. Traffic light relevance may be one cause of misdetections for red traffic light violations or non-detections of traffic light violations. In a scene captured from the intersection in which the traffic light regulates the passage of vehicles, dozens of traffic lights may be turned on at the same time and with different colors. For example, some traffic lights may be red, other traffic lights may be yellow, and still other traffic lights may be green. A determination as to which traffic light regulates a passage for a given vehicle (and corresponding driver) may be challenging. Such a traffic light may be considered to be a relevant traffic light. In the scene, zero, one, or more traffic lights may be considered to be relevant traffic lights. In some cases, especially with multiple lanes, determining which traffic light is relevant to a particular vehicle may be difficult.

As an example, in a scene, the only relevant traffic light out of multiple traffic lights may be a traffic light in the middle of the scene, as a traffic light in a left portion of the scene may be regulating just a left turn and a traffic light in a right portion of the scene may be regulating a crossing for pedestrians. In another example, in a scene, one traffic light may be considered to be relevant when the vehicle is performing a right turn. In this case, the relevant traffic light may not be aligned with a center of the scene, so knowledge of a context of the vehicle's movement (e.g., performing the right turn) may be needed to determine which traffic light is relevant. In these examples, detecting which traffic light is relevant to the vehicle may be challenging.

As an example, in a scene, a traffic light on a highway ramp may turn green just for a few seconds, which may indicate that a single vehicle is able to pass. When the vehicle is actually passing the traffic light, a state of the traffic light may already be red again. As another example, in a scene, a traffic light may be red, but the vehicle may lawfully make a right turn when the traffic light is red. In this example, such an event should not be classified as a traffic light violation, even though the traffic light is red when the vehicle makes the right turn. As yet another example, a traffic light may flash red or yellow (depending on different meanings), and generally a vehicle may be permitted to cross an intersection in such a scenario, which may happen more frequently at night. In these examples, the vehicle may legally cross a relevant traffic light while the traffic light's state is red, which may mistakenly trigger a traffic light violation to be detected.

In some implementations, an anti-causal algorithm, using speed and video, may combine deep learning models with heuristics to accurately detect traffic light violations in videos obtained from connected vehicles. The detection of traffic light violations may be without the usage of high-definition satellite map information. The detection of traffic light violations may be part of a fleet management application. The detection of traffic light violations may be relatively accurate, even in the presence of multiple traffic lights and even when the vehicle performs a special case (e.g., making a right turn on a red light). The detection of traffic light violations may be used to identify coachable events, so that drivers in a commercial fleet may improve their behavior and increase overall safety.

In some implementations, by combining speed information, video information, deep learning models, and/or heuristics, video obtained from a connected vehicle may be analyzed to accurately detect traffic light violations. Video captured by a camera onboard the vehicle may be analyzed to determine whether the vehicle unlawfully crosses an intersection when the traffic light is red. The anti-causal algorithm may be able to account for corner cases, such as traffic lights on highway ramps that are green for only a short period of time, lawfully permitted right turns by vehicles even when the traffic light is red, and/or traffic lights that flash red or yellow during which the vehicle is permitted to cross the intersection. Such corner cases may be considered and may not unnecessarily result in false traffic light violation predictions. As a result, an ability to accurately predict whether traffic light violations occur may be achieved, thereby improving an overall system performance.

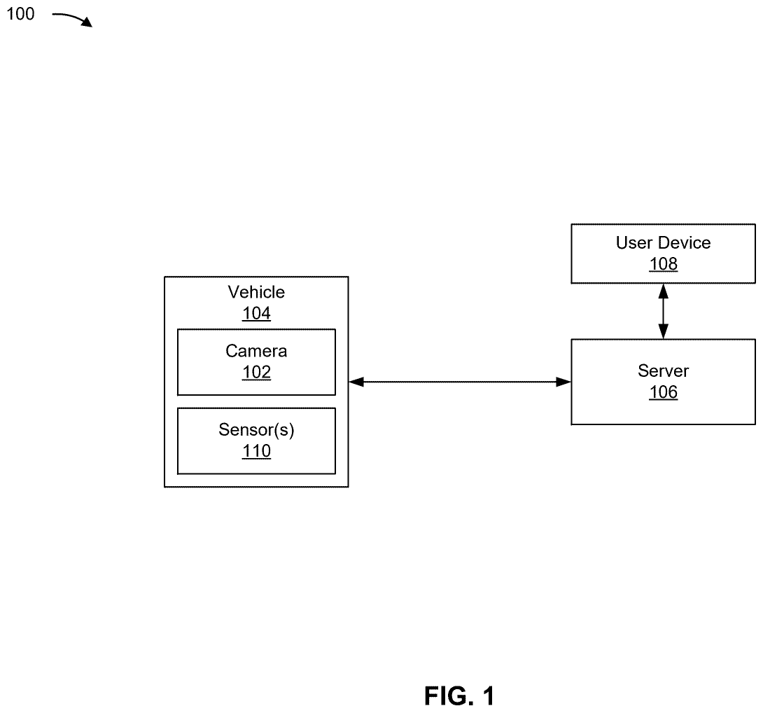

FIG. 1 is a diagram of an example 100 associated with detecting traffic light violations. As shown in FIG. 1, example 100 includes a camera 102, a vehicle 104, a server 106, a user device 108, and sensor(s) 110. The camera 102 may be onboard the vehicle 104. For example, the camera 102 may be installed on a dashboard of the vehicle 104.

The camera 102 may capture a video recording of a scene surrounding the vehicle 104. The camera 102 may be able to record video of the scene that is in front of the vehicle. For example, the camera 102 may be able to record objects and pedestrians that are in front of the vehicle. The camera 102 may be continuously recording the scene when the vehicle is turned on.

One or more sensors 110 may capture sensor information. The one or more sensors 110 may include a gyroscope. The gyroscope may be integrated with the camera 102, or the gyroscope may be external to the camera 102. In this example, the sensor information may include rotation information, orientation information, and/or angular velocity information associated with the vehicle 104. The one or more sensors 110 may include a global positioning system (GPS). In this example, the sensor information may include speed information associated with the vehicle 104.

The camera 102 (or another computing device associated with the vehicle 104) may transmit the video recording and the sensor information to the server 106, where the server 106 may detect a traffic light violation based on the video recording and the sensor information. Alternatively, the video recording and the sensor information may be processed locally by the computing device associated with the vehicle 104. In this example, a traffic light violation detection may be performed locally at the vehicle 104. The server 106 may obtain the video recording and the sensor information, where the video recording may be of the scene captured by the camera 102 onboard the vehicle 104, and the sensor information may be associated with the vehicle 104 (e.g., orientation information and/or speed information).

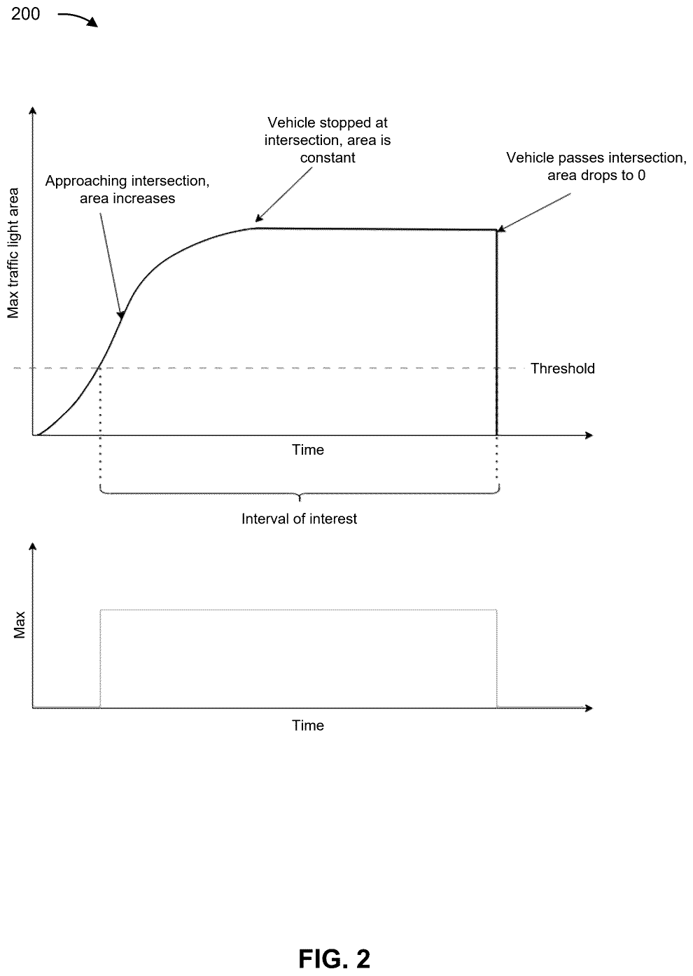

The server 106 may perform an object detection (OD) that indicates a presence of a traffic light in a frame of the video recording. The object detection is described in greater detail in FIG. 2. The object detection may not necessarily detect which traffic light of multiple traffic lights is relevant in the frame. Rather, the object detection may be used to determine whether one or more traffic lights are present in the frame, and which color(s) are associated with the traffic lights. A red traffic light may indicate that the vehicle 104 is to stop at an intersection, a yellow traffic light may indicate that the vehicle 104 is to slow down and stop at the intersection if possible, and a green traffic light may indicate that the vehicle 104 is allowed to pass the intersection without stopping.

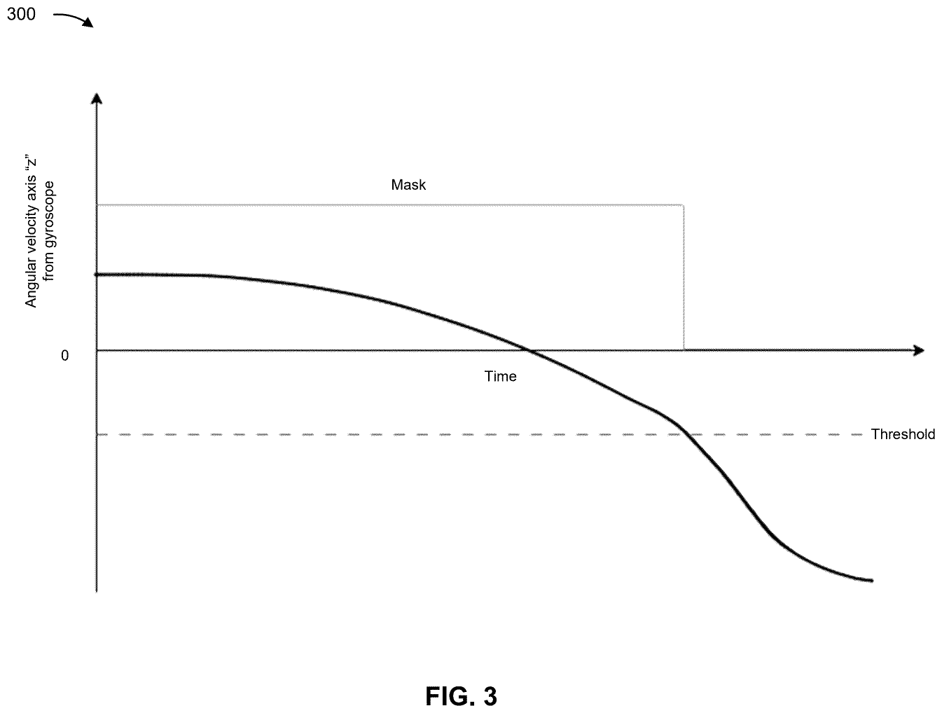

The server 106 may perform, based on the sensor information, a turn detection (RT) that indicates whether the vehicle 104 is performing a turn during the frame. The turn detection is described in greater detail in FIG. 3. For example, the turn detection may be used to detect whether the vehicle 104 is performing a right turn on the intersection. A right turn detection may be useful because, in some cases, the vehicle 104 may be permitted to make the right turn even when the traffic light is red. In other words, such an action may not constitute a traffic signal violation. The server 106 may determine whether the vehicle 104 is making the right turn based on gyroscope information.

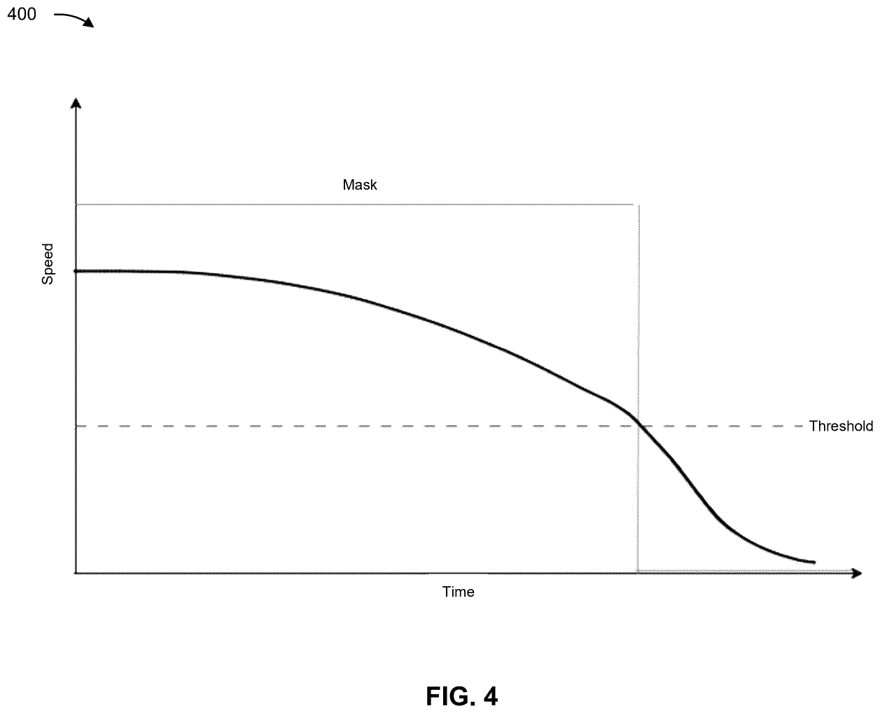

The server 106 may perform, based on the sensor information, a speed detection(S) that indicates a speed associated with the vehicle 104 during the frame. The speed detection is described in greater detail in FIG. 4. The vehicle 104 may include a GPS that tracks a speed of the vehicle 104 in real-time. The server 106 may correlate a timestamp associated with the frame and a timestamp associated with the speed of the vehicle 104, such that the server 106 may be able to determine, when the frame was taken, the speed of the vehicle 104 at that time.

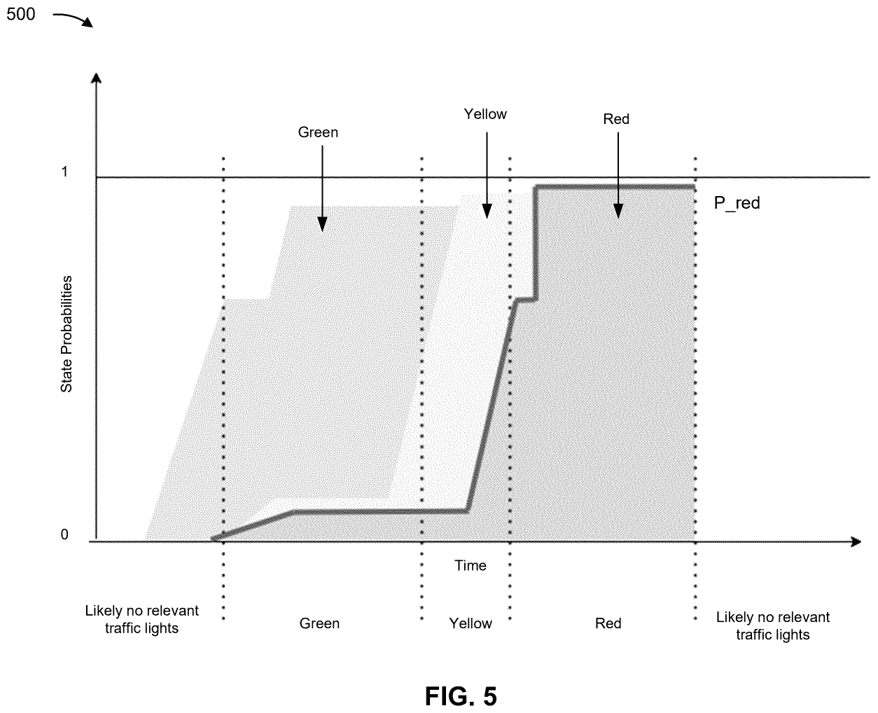

The server 106 may determine, based on an image classifier, a red light probability (P_{red}) that the frame contains at least one relevant red traffic light for the vehicle 104. The red light probability is described in greater detail in FIG. 5. The image classifier may be used to categorize road images captured by the camera. The image classifier may be fed with additional inputs other than an image, such as the results of on an object detector with multiple attributes, and the multiple attributes may include a first attribute for traffic light relevance and a second attribute for traffic light state. The image classifier may be trained using a training set, where the training set may include a plurality of historical images. As a result, the server 106 may determine, for the frame, a probability that a particular red light is relevant to the vehicle 104.

The server 106 may calculate a violation score based on the object detection, the turn detection, and the red light probability with respect to the frame, and based on the speed detection. The violation score may account for, based on a grace period, a traffic light that turns green for a limited time period that allows only a single vehicle to pass and then turns red. The violation score may account for the vehicle making a lawfully permitted right turn when the traffic light is red. The frame may be one of multiple frames, and the violation score may account for the traffic light flashing red or flashing yellow based on the multiple frames. The violation score may be a numerical value, and the violation score may fall within a defined range (e.g., 0 to 1, or 0 to 100). The violation score may be computed using different components, which may be related to the object detection, the turn detection, the red light probability, and/or the speed detection.

In some implementations, the server 106 may determine, based on the image classifier, a not relevant probability that the frame contains no traffic light or that the frame contains one or more traffic lights that are not relevant to the vehicle 104, and/or a green light probability that the frame contains at least one relevant green traffic light for the vehicle 104.

The server 106 may determine whether the vehicle is associated with a traffic light violation based on the violation score in relation to a threshold. The server may compare the violation score to the threshold, and depending on whether the violation score satisfies the threshold, the server 106 may predict that the traffic light violation has occurred. The traffic light violation may involve the vehicle driving past the intersection when the traffic light is red, and no exception exists that lawfully permits the vehicle to cross the intersection when the traffic light is red. A detection of the traffic light violation may be based on video information, speed information, and heuristics, and the detection of the traffic light violation may be without a use of satellite map information. In other words, the detection of the traffic light violation may not be based on satellite map information.

In some implementations, as part of a traffic light violation detector, multiple time series may be combined together in a single violation score. A time series may be given by: R(t)=OD(t)*RT(t)*P_{red}(t), where t denotes a given frame, OD is associated with object detection, RT is associated with right turn detection, and P_{red} is associated with a probability of a relevant red traffic light. When a value of R(t) is close to one, the vehicle 104 may be in the presence of a relevant red traffic light since the object detection mask is not zero, P_{red} is close to one, and the vehicle 104 is not turning right since RT(t) is not zero.

In some implementations, an aggregation of the time series P_{not_relevant} over a rolling window of length T may be represented by:

$$NR ( t ) = \frac{1}{T} {\sum }_{x = t}^{t + T} {P}_{{not}_{relevant}} ( x ) ,$$

where P_{not_relevant} is associated with a probability of no relevant traffic light. Ideally, right after the vehicle 104 passes through the intersection, a value may change from zero to close to one (e.g., a probability of any traffic light state dropped to zero), meaning that no traffic light is detected in an upcoming time window of length T. Before passing the intersection, one of the probabilities for other colors (e.g., green, yellow, or red) may be close to one. When R(t)*NR(t) is close to one for some value t′, then at time t′ the vehicle 104 may have run a red light (which may not necessarily mean a traffic light violation). The vehicle 104 may have stopped late at the intersection and the traffic light may no longer be visible, or a camera installation may cause a camera to be pointed downward, and in proximity of the intersection, so that the traffic light may quickly disappear from the camera field of view. In these cases, no traffic light violation may actually occur, but a false positive may be triggered. To account for such cases, the speed of the vehicle may be considered. When the speed is below a given threshold, the traffic light violation may not be considered to be possible, so an actual score may be given by: violation_scoreR=R(t)*NR(t)*S(t), where S is associated with the speed detection.

In some implementations, to make the violation score more robust, filtering may be applied to a speed mask. The filtering may involve calculating a mean speed over a rolling window. If the traffic light violation happens at a very low speed, a detection of the traffic light violation may not be possible. A GPS speed may already have some uncertainty and considering zero as a limit value without any tolerance may not be feasible.

In some implementations, a time series P_{green} may be considered for a highway ramp scenario (e.g., a traffic light flashes between green and red), where P_{green} is associated with a probability of a relevant green traffic light. When a relevant traffic light state transitions from red to green (or green to red), a grace period may be used for the next few seconds. The grace period may serve to artificially set a score to zero. For detecting a transition from red to green (or green to red), the time series P_{green} may be aggregated and a value of its product may be monitored with R (t), such that:

$$GR ( t ) = \frac{1}{T} {\sum }_{x = t}^{t + T} {P}_{green} ( x ) ,$$

where for a red-green transition to occur, R(t)*GR(t)˜1 should be satisfied.

In some implementations, one scenario that may be accounted for is flashing traffic lights. In this scenario, a state transition from red to not relevant may be periodic. In NR(t), an average of a not relevant probability may be taken over a next T seconds. When a flashing period is less than T (e.g., 0.5*T), NR will be equal to 0.5, and hence this particular event may be ranked in a lower position then an actual red light violation. The traffic light violation may be predicated when a score is above a threshold/confidence score, where the threshold/confidence score may be determined by monitoring a performance of an algorithm in a dataset. An additional minimum filter may be applied to the score, which may avoid a bad prediction of a relevant state, even when just happening for one frame, leading to a false positive. Further, an anti-causal window may be used, such that the score cannot be computed in real time, but rather with a delay that is at least equal to a length of a time window.

In some implementations, the server 106 may determine, based on the image classifier, a yellow light probability that the frame contains at least one relevant yellow traffic light for the vehicle 104. The server 106 may determine, based on the image classifier, the not relevant probability that the frame contains no traffic light or that the frame contains one or more traffic lights that are not relevant to the vehicle 104. The server 106 may perform, based on the sensor information, the speed detection that indicates the speed associated with the vehicle 104 during the frame. The server 106 may determine a yellow stop score that indicates a severity of a yellow light violation. The yellow stop score may be based on the speed and a duration of a detected yellow relevant traffic light. The server 106 may calculate the violation score based on the object detection, the turn detection, the yellow light probability, the not relevant probability, the speed detection, and the yellow stop score.

In some implementations, the vehicle 104 may run a yellow light. Passing through a traffic light regulated stop with a yellow light turned on may not necessarily be a traffic light violation. The vehicle 104 should stop at the traffic light when possible, and the vehicle 104 is permitted to not stop at the traffic light when not possible. Given that Y(t)=OD(t)*RT (t)*P_{yellow}(t), when Y(t)*NR(t) is close to one for some value t′, a yellow light violation may have happened at t′. In this example, P_{yellow} is associated with a probability of a relevant yellow traffic light. A violation score may be represented by: violation_score_{Y}=Y(t)*NR(t)*S(t)*YellowStopScore, where YellowStopScore may capture a severity of a yellow light violation. The severity of the yellow light violation may leverage a speed of the vehicle 104 and a duration of a detected yellow relevant traffic light. In a specific example, YellowStopScore=Duration_{Y}(t)*60/min (S(t), 60). A higher duration of the yellow traffic light may result in a higher YellowStopScore (e.g., a yellow light that is seen for a longer period of time gives a driver of the vehicle 104 more opportunity to stop the vehicle 104 in time). On the other hand, a duration may be divided by a term that considers a minimum of the speed and a threshold that is set to 60 km/h. In this way, when the vehicle 104 is traveling 60 km/h or more, this term may be set to one. When the vehicle 104 is traveling at a slower speed (e.g., a speed less than 60 km/h), this term may increase and raise an overall YellowStopScore. For a vehicle 104 that is traveling relatively fast, stopping at a yellow light may be less feasible, but for a vehicle 104 that is traveling relatively slow, stopping at the yellow light may be more feasible.

As shown by reference number 140, the server 106 may transmit, to the user device 108, a notification that indicates whether the vehicle 104 is associated with the traffic light violation. The user device 108 may be associated with the driver of the vehicle 104. In this example, the notification may indicate a recommendation for the driver of the vehicle 104 to improve a driving behavior and increase safety in response to the traffic light violation. The user device 108 may be associated with a supervisor of the driver. In this example, the notification may indicate that the driver was involved in the traffic light violation.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example 200 associated with object detection.

In some implementations, object detection may be used for road scene analysis. Object detection may be used to determine, at each frame of a video, a location, a size, and/or a shape of each traffic light. Object detection may not provide information regarding traffic light relevance and state, but may be used to check the presence of traffic lights in a given video. An absence of a traffic light in the video, as determined using object detection, may result in no detection of a traffic light violation because a presence of a traffic light is critical for detecting the traffic light violation.

In some implementations, results of object detection may be used to create a mask to select time windows that may be of interest for traffic light violation detection in the given video. A time series given by a maximum area of the traffic lights detected in all frames of the video may be analyzed. When no traffic light is present, a value of the time series may be set to zero. Intervals of interest may be an interval in which a value of the time series is above a certain threshold. A resulting mask may be a time series that is set to zero when the value is below the threshold and set to one elsewhere. The resulting mask may be known as a square wave.

As shown in FIG. 2, for object detection, when a vehicle approaches an intersection, a maximum traffic light area in an image of a scene may increase from zero to a certain value, which may be due to the movement of the vehicle towards a traffic light. When the vehicle is stopped at the intersection, the maximum traffic light area may be constant for a period of time. When the vehicle passes the intersection, the traffic light may no longer be detected, so the maximum traffic light area may drop to zero. An interval of interest may start as the vehicle approaches the intersection (e.g., once a certain threshold is satisfied) and the area of interest may end when the vehicle passes the intersection. A mask (OD) may be created that corresponds to the interval of interest. The resulting mask may be set to one during the interval of interest, and the resulting mask may be set to zero at other times.

As indicated above, FIG. 2 is provided as an example. Other examples may differ from what is described with regard to FIG. 2.

FIG. 3 is a diagram of an example 300 associated with turn detection.

In some implementations, turn detection may be used for detecting a right turn of a vehicle. When the vehicle is permitted to turn right at an intersection at a red light, a traffic light violation should not be predicted. The vehicle may initially stop at the red light, and then after a period of time (e.g., two seconds), the vehicle may be lawfully permitted to make the right turn while the traffic light is still red. The vehicle may have to initially stop at the red light based on a traffic sign that instructs a driver of the vehicle to stop. For the turn detection, a z-axis component of an angular velocity measured by a gyroscope sensor in the camera may be used. When a value of the z-axis component is a negative value, the vehicle may be turning right. A mask may be created, where the mask may start from an angular velocity checking whenever the value is below a given negative threshold. The mask may be made narrower by adding a fixed buffer of X seconds before and after the zero seconds, where X is a positive integer. An estimate may become more robust when, instead of an instantaneous value, a mean filter is applied on the angular velocity.

As shown in FIG. 3, for turn detection, the z-axis component of the angular velocity may be tracked over a period of time. A value of the z-axis component being below a given negative threshold may indicate that the vehicle is making the right turn. A mask (RT) may be created, starting from a positive value of the z-axis component, to check whenever the value falls below the given negative threshold, which may indicate that the vehicle is making the right turn. The mask may be set to one when the value of the z-axis component is above the given negative threshold. The mask may be set to zero when the value of the value of the z-axis component reaches the given negative threshold and a right turn is detected.

As indicated above, FIG. 3 is provided as an example. Other examples may differ from what is described with regard to FIG. 3.

FIG. 4 is a diagram of an example 400 associated with speed detection.

As shown in FIG. 4, for speed detection, a detection of a traffic light violation may depend on a speed of a vehicle. The vehicle may have to move at a given speed in order to run a red light. When the vehicle is stopped, a traffic light violation may not be possible. The speed of the vehicle may be measured using a GPS associated with the vehicle. A mask(S) may be created to track the speed of the vehicle over a period of time. When the speed is below a certain threshold, the mask may be set to zero. When the speed is above the certain threshold, the mask may be set to one.

As indicated above, FIG. 4 is provided as an example. Other examples may differ from what is described with regard to FIG. 4.

FIG. 5 is a diagram of an example 500 associated with traffic light state classification.

In some implementations, for traffic light state classification, an image classifier may be used to categorize road images into different classes. An image in which no traffic light is present, or an image that has at least one traffic light but none of the traffic lights are relevant for a vehicle that is capturing the image, may be associated with a not relevant class. An image in which at least one relevant green traffic light is present for the vehicle may be associated with a relevant green class. An image in which at least one relevant yellow traffic light is present for the vehicle may be associated with a relevant yellow class. An image in which at least one relevant red traffic light is present for the vehicle may be associated with a relevant red class. The image classifier may be run for each frame in a video, which may produce a time series containing probabilities for each state (e.g., not relevant, relevant green, relevant yellow, or relevant red). A complementary value to a sum of the probabilities of each of the colors (e.g., green, yellow, and red) may represent a probably that no relevant traffic light is present for the vehicle. Each one of the time series may be represented by P_{not_relevant}, P_{green}, P_{yellow}, and P_{red}, where P_{not_relevant} is associated with a probability of no relevant traffic light, P_{green} is associated with a probability of a relevant green traffic light, P_{yellow} is associated with a probability of a relevant yellow traffic light, and P_{red} is associated with a probability of a relevant red traffic light. In some cases, the image classifier may not be used, but rather an object detector with multiple attributes (e.g., one attribute for traffic light relevance and one attribute for state) may be used instead. When a probability of a given state drops to zero and a dominant probability becomes not relevant, the vehicle may have just passed an intersection.

As shown in FIG. 5, a time series of images may be captured by a camera onboard a vehicle. Initially, the image classifier may determine that one or more frames indicate that no relevant traffic light is likely, which may be based on a state probability. After a certain point of time, the image classifier may determine that one or more frames indicate that a green traffic light is likely, which may be based on the state probability. The image classifier may then determine that one or more frames indicate that a yellow light is likely, which may be based on the state probability. The image classifier may then determine that one or more frames indicate that a red light is likely, which may be based on the state probability. A traffic light may change from green, to yellow, and to red as the vehicle approaches an intersection. After a certain point of time at which the red light is likely, the state probability may switch to zero, at which point no relevant traffic light is likely. The state probability may switch to zero as a result of the vehicle passing the intersection (e.g., the red light is no longer present in the frame). When the vehicle passes the red light, a potential traffic light violation may occur. For example, a traffic light violation may occur when the vehicle passes the intersection and the traffic light is still red. Further, as shown in FIG. 5, a time series of P_{red} may indicate a value close to zero when no relevant traffic light is likely, when the green light is likely, and when the yellow light is likely. When the red light becomes likely, P_{red} may increase to one (indicating that a presence of at least one relevant red traffic light is very likely).

As indicated above, FIG. 5 is provided as an example. Other examples may differ from what is described with regard to FIG. 5.

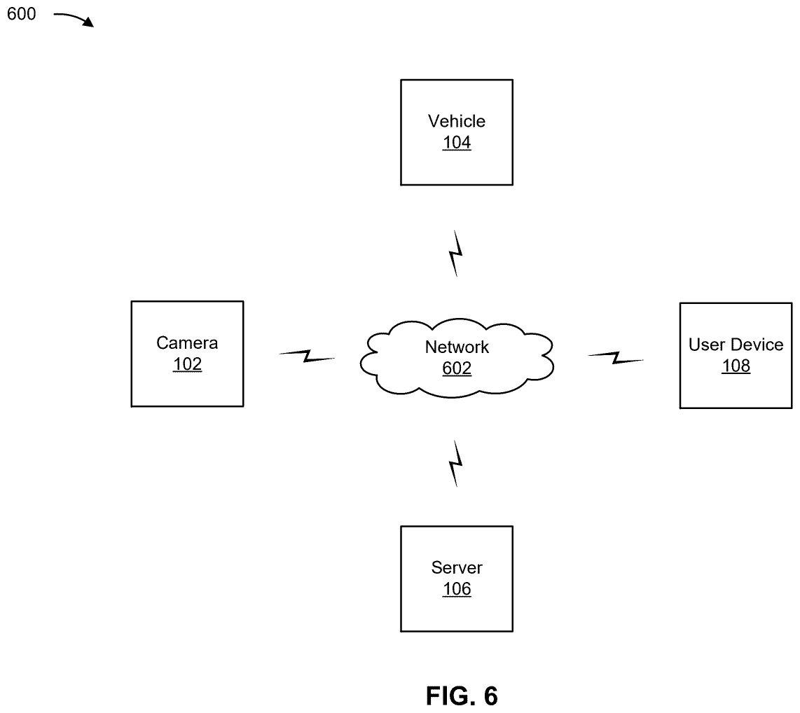

FIG. 6 is a diagram of an example environment 600 in which systems and/or methods described herein may be implemented. As shown in FIG. 6, environment 600 may include a camera 102, a vehicle 104, a server 106, a user device 108, and a network 602. Devices of environment 600 may interconnect via wired connections, wireless connections, or a combination of wired and wireless connections.

In some implementations, the camera 102 may be onboard the vehicle 104. For example, the camera 102 may be installed on a dashboard of the vehicle 104. The camera 102 may be able to record video of a scene in front of the vehicle. For example, the camera 102 may be able to record objects and pedestrians that are in front of the vehicle.

The server 106 may include one or more devices capable of receiving, generating, storing, processing, providing, and/or routing information associated with detecting traffic light violations, as described elsewhere herein. The server 106 may include a communication device and/or a computing device. For example, the server 106 may include a server, such as an application server, a client server, a web server, a database server, a host server, a proxy server, a virtual server (e.g., executing on computing hardware), or a server in a cloud computing system. In some implementations, the server 106 may include computing hardware used in a cloud computing environment.

The user device 108 may include one or more devices capable of receiving, generating, storing, processing, and/or providing information associated with detecting traffic light violations, as described elsewhere herein. The user device 108 may include a communication device and/or a computing device. For example, the user device 108 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 602 may include one or more wired and/or wireless networks. For example, the network 602 may include a cellular network (e.g., a Fifth Generation (5G) network, a Fourth Generation (4G) network, a long-term evolution (LTE) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 602 enables communication among the devices of environment 600.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

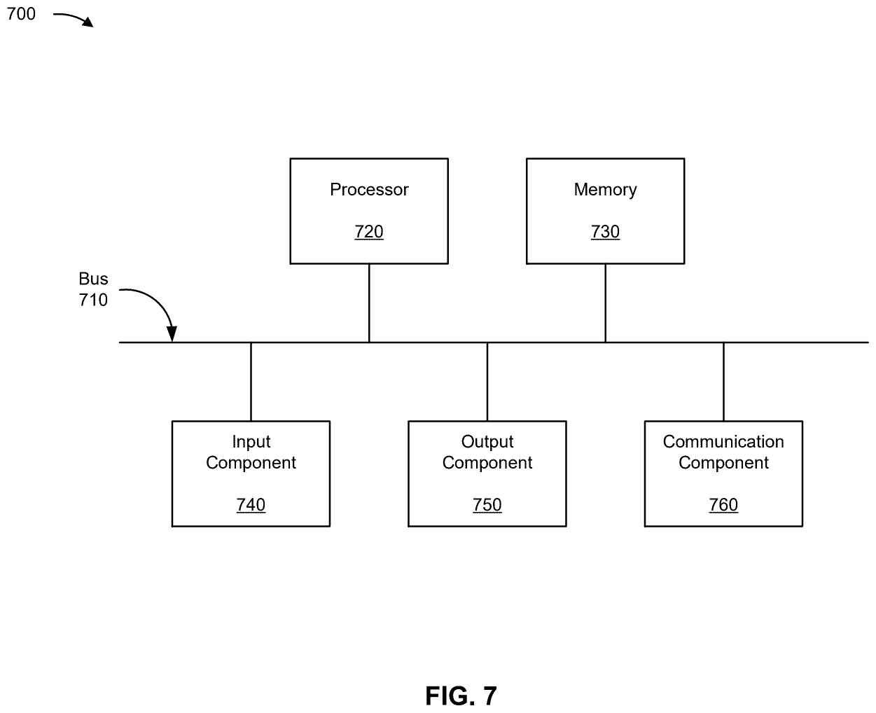

FIG. 7 is a diagram of example components of a device 700 associated with detecting traffic light violations. The device 700 may correspond to a server (e.g., server 106). In some implementations, the server may include one or more devices 700 and/or one or more components of the device 700. As shown in FIG. 7, the device 700 may include a bus 710, a processor 720, a memory 730, an input component 740, an output component 750, and/or a communication component 760.

The bus 710 may include one or more components that enable wired and/or wireless communication among the components of the device 700. The bus 710 may couple together two or more components of FIG. 7, such as via operative coupling, communicative coupling, electronic coupling, and/or electric coupling. For example, the bus 710 may include an electrical connection (e.g., a wire, a trace, and/or a lead) and/or a wireless bus. The processor 720 may include a central processing unit, a graphics processing unit, a microprocessor, a controller, a microcontroller, a digital signal processor, a field-programmable gate array, an application-specific integrated circuit, and/or another type of processing component. The processor 720 may be implemented in hardware, firmware, or a combination of hardware and software. In some implementations, the processor 720 may include one or more processors capable of being programmed to perform one or more operations or processes described elsewhere herein.

The memory 730 may include volatile and/or nonvolatile memory. For example, the memory 730 may include random access memory (RAM), read only memory (ROM), a hard disk drive, and/or another type of memory (e.g., a flash memory, a magnetic memory, and/or an optical memory). The memory 730 may include internal memory (e.g., RAM, ROM, or a hard disk drive) and/or removable memory (e.g., removable via a universal serial bus connection). The memory 730 may be a non-transitory computer-readable medium. The memory 730 may store information, one or more instructions, and/or software (e.g., one or more software applications) related to the operation of the device 700. In some implementations, the memory 730 may include one or more memories that are coupled (e.g., communicatively coupled) to one or more processors (e.g., processor 720), such as via the bus 710. Communicative coupling between a processor 720 and a memory 730 may enable the processor 720 to read and/or process information stored in the memory 730 and/or to store information in the memory 730.

The input component 740 may enable the device 700 to receive input, such as user input and/or sensed input. For example, the input component 740 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 750 may enable the device 700 to provide output, such as via a display, a speaker, and/or a light-emitting diode. The communication component 760 may enable the device 700 to communicate with other devices via a wired connection and/or a wireless connection. For example, the communication component 760 may include a receiver, a transmitter, a transceiver, a modem, a network interface card, and/or an antenna.

The device 700 may perform one or more operations or processes described herein. For example, a non-transitory computer-readable medium (e.g., memory 730) may store a set of instructions (e.g., one or more instructions or code) for execution by the processor 720. The processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, the processor 720 may be configured to perform one or more operations or processes described herein. Thus, implementations described herein are not limited to any specific combination of hardware circuitry and software.

The number and arrangement of components shown in FIG. 7 are provided as an example. The device 700 may include additional components, fewer components, different components, or differently arranged components than those shown in FIG. 7. Additionally, or alternatively, a set of components (e.g., one or more components) of the device 700 may perform one or more functions described as being performed by another set of components of the device 700.

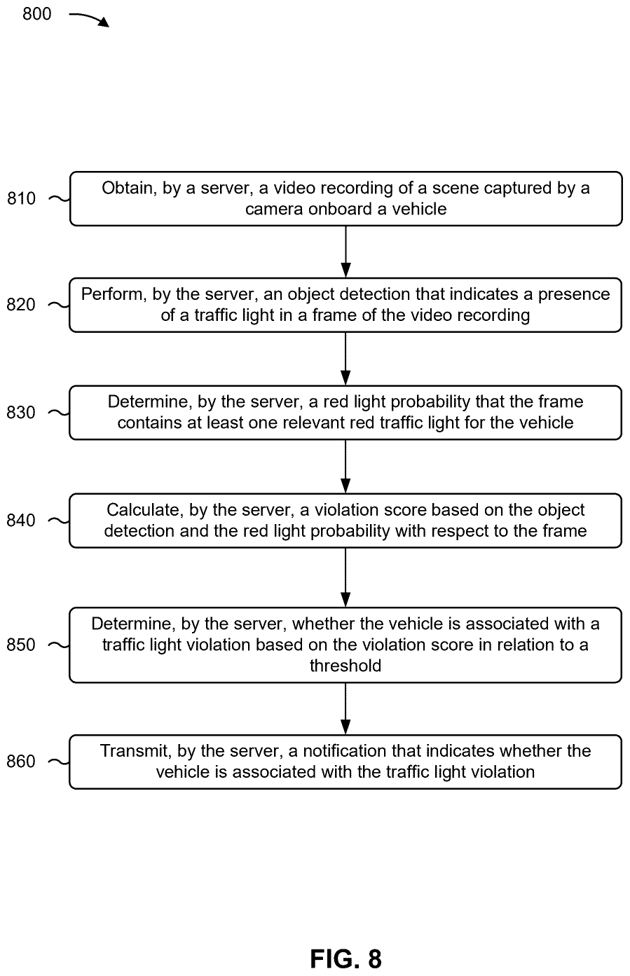

FIG. 8 is a flowchart of an example process 800 associated with detecting traffic light violations. In some implementations, one or more process blocks of FIG. 8 may be performed by a server (e.g., server 106). In some implementations, one or more process blocks of FIG. 8 may be performed by another device or a group of devices separate from or including the server. Additionally, or alternatively, one or more process blocks of FIG. 8 may be performed by one or more components of device 700, such as processor 720, memory 730, input component 740, output component 750, and/or communication component 760.

As shown in FIG. 8, process 800 may include obtaining, by the server, a video recording of a scene captured by a camera onboard a vehicle (block 810). The camera may capture the scene, and then the camera may upload the video recording to the server. The camera may be a dashboard camera installed on a dashboard of the vehicle. The camera may continuously record video when the vehicle is turned on.

In some implementations, the server may obtain sensor information associated with the vehicle. The sensor information may include rotation information, which may be obtained from a gyroscope associated with the camera and/or the vehicle. The sensor information may include speed information, which may be obtained from a GPS associated with the vehicle. The server may perform, by the server and based on the sensor information, a turn detection that indicates whether the vehicle is performing a turn. The turn detection may be based on the rotation information. In other words, a certain value in the rotation information may indicate whether or not the vehicle is turning in a particular direction (e.g., turning right).

As shown in FIG. 8, process 800 may include performing, by the server, an object detection that indicates a presence of a traffic light in a frame of the video recording (block 820). The object detection may be used to determine whether the frame shows the traffic light, and if so, a color associated with the traffic light (e.g., red, yellow, or green).

As shown in FIG. 8, process 800 may include determining, by the server, a red light probability that the frame contains at least one relevant red traffic light for the vehicle (block 830). In some cases, the server may determine the red light probability using an image classifier. The image classifier may be used to categorize road images captured by the camera. The image classifier may be based on an object detector with multiple attributes, and the multiple attributes may include a first attribute for traffic light relevance and a second attribute for traffic light state. In some implementations, the vehicle may receive, from a device associated with a smart city technology, an indication of a relevant traffic light state. In this example, the server may determine the relevant traffic light state based on the received indication.

As shown in FIG. 8, process 800 may include calculating, by the server, a violation score based on the object detection and the red light probability with respect to the frame (block 840). In some cases, the violation score may also be based on the turn detection. The violation score may account for, based on a grace period, a traffic light that turns green for a limited time period that allows only a single vehicle to pass and then turns red. The violation score may account for the vehicle making a lawfully permitted right turn when the traffic light is red. The violation score may account for the traffic light flashing red or flashing yellow. In some cases, the vehicle may calculate the violation score based on the relevant traffic light state.

As shown in FIG. 8, process 800 may include determining, by the server, whether the vehicle is associated with a traffic light violation based on the violation score in relation to a threshold (block 850). The traffic light violation may involve the vehicle driving past an intersection when the traffic light is red, and no exception exists that lawfully permits the vehicle to cross the intersection when the traffic light is red. A detection of the traffic light violation may be based on video information, speed information, and heuristics, and the detection of the traffic light violation may be without a use of satellite map information.

As shown in FIG. 8, process 800 may include transmitting, by the server, a notification that indicates whether the vehicle is associated with the traffic light violation (block 860). The notification may indicate a recommendation for a driver of the vehicle to improve a driving behavior and increase safety in response to the traffic light violation.

In some implementations, the server may determine a not relevant probability that the frame contains no traffic light or that the frame contains one or more traffic lights that are not relevant to the vehicle. The server may perform, based on the sensor information, a speed detection that indicates a speed associated with the vehicle during the frame. The server may calculate the violation score based on the not relevant probability and the speed detection. In some implementations, the server may determine a green light probability that the frame contains at least one relevant green traffic light for the vehicle. The server may calculate the violation score based on the green light probability. In some cases, the server may determine the not relevant probability and/or the green light probability using the image classifier.

In some implementations, server may determine, based on the image classifier, a yellow light probability that the frame contains at least one relevant yellow traffic light for the vehicle. The server may determine the not relevant probability that the frame contains no traffic light or that the frame contains one or more traffic lights that are not relevant to the vehicle. The server may perform, based on the sensor information, a speed detection that indicates a speed associated with the vehicle during the frame. The server may determine a yellow stop score that indicates a severity of a yellow light violation, where the yellow stop score may be based on the speed and a duration of a detected yellow relevant traffic light. The server may calculate the violation score based on the object detection, the turn detection, the yellow light probability, the not relevant probability, the speed detection, and the yellow stop score.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
obtaining, by a server, a video recording of a scene captured by a camera onboard a vehicle;
performing, by the server, an object detection that indicates a presence of a traffic light in a frame of the video recording;
determining, by the server, a red light probability that the frame contains at least one relevant red traffic light for the vehicle;
calculating, by the server, a violation score based on the object detection and the red light probability with respect to the frame;
determining, by the server, whether the vehicle is associated with a traffic light violation based on the violation score in relation to a threshold; and
transmitting, by the server, a notification that indicates whether the vehicle is associated with the traffic light violation.

2. The method of claim 1, further comprising:
obtaining, by the server, sensor information associated with the vehicle; and
performing, by the server and based on the sensor information, a turn detection that indicates whether the vehicle is performing a turn, wherein the violation score is calculated based on the turn detection.

3. The method of claim 1, further comprising:
determining, by the server, a not relevant probability that the frame contains no traffic light or that the frame contains one or more traffic lights that are not relevant to the vehicle;
performing, by the server and based on the sensor information, a speed detection that indicates a speed associated with the vehicle during the frame; and
calculating, by the server, the violation score based on the not relevant probability and the speed detection.

4. The method of claim 1, further comprising:
determining, by the server, a green light probability that the frame contains at least one relevant green traffic light for the vehicle; and
calculating the violation score based on the green light probability.

5. The method of claim 1, wherein the violation score is a first violation score, and further comprising:
determining, by the server, a yellow light probability that the frame contains at least one relevant yellow traffic light for the vehicle;
determining, by the server, a not relevant probability that the frame contains no traffic light or that the frame contains one or more traffic lights that are not relevant to the vehicle;
performing, by the server and based on the sensor information, a speed detection that indicates a speed associated with the vehicle during the frame;
determining, by the server, a yellow stop score that indicates a severity of a yellow light violation, wherein the yellow stop score is based on the speed and a duration of a detected yellow relevant traffic light; and
calculating a second violation score based on the object detection, a turn detection, the yellow light probability, the not relevant probability, the speed detection, and the yellow stop score.

6. The method of claim 1, wherein the violation score accounts for, based on a grace period, a traffic light that turns green for a limited time period that allows only a single vehicle to pass and then turns red, and the violation score accounts for the vehicle making a lawfully permitted right turn when the traffic light is red.

7. The method of claim 1, wherein the frame is one of multiple frames, and the violation score accounts for the traffic light flashing red or flashing yellow based on the multiple frames.

8. The method of claim 1, wherein the red light probability is determined based on an image classifier, the image classifier is based on an object detector with multiple attributes, and the multiple attributes include a first attribute for traffic light relevance and a second attribute for traffic light state.

9. The method of claim 1, wherein the notification indicates a recommendation for a driver of the vehicle to improve a driving behavior and increase safety in response to the traffic light violation.

10. The method of claim 1, wherein a detection of the traffic light violation is based on video information, speed information, and heuristics, and the detection of the traffic light violation is not based on satellite map information.

11. A device, comprising:
one or more processors configured to:
obtain a video recording of a scene captured by a camera onboard a vehicle;
obtain sensor information associated with the vehicle;
perform an object detection that indicates a presence of a traffic light in a frame of the video recording;
perform, based on the sensor information, a turn detection that indicates whether the vehicle is performing a turn;
determine a red light probability that the frame contains at least one relevant red traffic light for the vehicle;
calculate a violation score based on the object detection, the turn detection, and the red light probability with respect to the frame;
determine whether the vehicle is associated with a traffic light violation based on the violation score in relation to a threshold; and
transmit a notification that indicates whether the vehicle is associated with the traffic light violation.

12. The device of claim 11, wherein the one or more processors are further configured to:
determine a not relevant probability that the frame contains no traffic light or that the frame contains one or more traffic lights that are not relevant to the vehicle;
perform, based on the sensor information, a speed detection that indicates a speed associated with the vehicle during the frame; and
calculate the violation score based on the not relevant probability and the speed detection.

13. The device of claim 11, wherein the one or more processors are further configured to:
determine, a green light probability that the frame contains at least one relevant green traffic light for the vehicle; and
calculate the violation score based on the green light probability.

14. The device of claim 11, wherein the violation score is a first violation score, and the one or more processors are further configured to:
determine a yellow light probability that the frame contains at least one relevant yellow traffic light for the vehicle;
determine a not relevant probability that the frame contains no traffic light or that the frame contains one or more traffic lights that are not relevant to the vehicle;
perform, based on the sensor information, a speed detection that indicates a speed associated with the vehicle during the frame;
determine a yellow stop score that indicates a severity of a yellow light violation, wherein the yellow stop score is based on the speed and a duration of a detected yellow relevant traffic light; and
calculate a second violation score based on the object detection, the turn detection, the yellow light probability, the not relevant probability, the speed detection, and the yellow stop score.

15. The device of claim 11, wherein:
the violation score accounts for, based on a grace period, a traffic light that turns green for a limited time period that allows only a single vehicle to pass and then turns red;
the violation score accounts for the vehicle making a lawfully permitted right turn when the traffic light is red; or
the frame is one of multiple frames, and the violation score accounts for the traffic light flashing red or flashing yellow based on the multiple frames.

16. A non-transitory computer-readable medium storing a set of instructions, the set of instructions comprising:
one or more instructions that, when executed by one or more processors of a device, cause the device to:
obtain a video recording of a scene captured by a camera onboard a vehicle;
obtain sensor information associated with the vehicle;
perform an object detection that indicates a presence of a traffic light in a frame of the video recording;
perform, based on the sensor information, a turn detection that indicates whether the vehicle is performing a turn;
determine a red light probability that the frame contains at least one relevant red traffic light for the vehicle;
calculate a violation score based on the object detection, the turn detection, and the red light probability with respect to the frame;
determine whether the vehicle is associated with a traffic light violation based on the violation score in relation to a threshold; and
transmit a notification that indicates whether the vehicle is associated with the traffic light violation.

17. The non-transitory computer-readable medium of claim 16, wherein the one or more instructions, when executed by the one or more processors, further cause the device to:
determine a not relevant probability that the frame contains no traffic light or that the frame contains one or more traffic lights that are not relevant to the vehicle;
perform, based on the sensor information, a speed detection that indicates a speed associated with the vehicle during the frame; and
calculate the violation score based on the not relevant probability and the speed detection.

18. The non-transitory computer-readable medium of claim 16, wherein the one or more instructions, when executed by the one or more processors, further cause the device to:
determine a green light probability that the frame contains at least one relevant green traffic light for the vehicle; and
calculate the violation score based on the green light probability.

19. The non-transitory computer-readable medium of claim 16, wherein the violation score is a first violation score, and the one or more instructions, when executed by the one or more processors, further cause the device to:
determine a yellow light probability that the frame contains at least one relevant yellow traffic light for the vehicle;
determine a not relevant probability that the frame contains no traffic light or that the frame contains one or more traffic lights that are not relevant to the vehicle;
perform, based on the sensor information, a speed detection that indicates a speed associated with the vehicle during the frame;
determine a yellow stop score that indicates a severity of a yellow light violation, wherein the yellow stop score is based on the speed and a duration of a detected yellow relevant traffic light; and
calculate a second violation score based on the object detection, the turn detection, the yellow light probability, the not relevant probability, the speed detection, and the yellow stop score.

20. The non-transitory computer-readable medium of claim 16, wherein:
the violation score accounts for, based on a grace period, a traffic light that turns green for a limited time period that allows only a single vehicle to pass and then turns red;
the violation score accounts for the vehicle making a lawfully permitted right turn when the traffic light is red; or
the frame is one of multiple frames, and the violation score accounts for the traffic light flashing red or flashing yellow based on the multiple frames.
